(19) United States
(12) Patent Application Publication
(10) Pub. No.: US 2013/0221134 A1
(43) Pub. Date: Aug. 29, 2013

(54) LIQUID EJECTING HEAD AND LIQUID EJECTING APPARATUS

(71) Applicant: SEIKO EPSON CORPORATION, (US)

(72) Inventor: Hiroyuki KOBAYASHI, Azumino-shi (JP)

(73) Assignee: SEIKO EPSON CORPORATION, Tokyo (JP)

(21) Appl. No.: 13/771,719

(22) Filed: Feb. 20, 2013

(30) Foreign Application Priority Data
Feb. 23, 2012 (JP) 2012-037117

(51) Int. Cl. B05B 15/08

(52) U.S. Cl. CPC B05B 15/08
USPC 239/536

(57) ABSTRACT

A liquid ejecting head includes head main bodies having nozzle rows in which nozzle openings configured to eject liquid are arranged; and a fixing member in which rows of the head main bodies arranged in a first direction as an arrangement direction of the nozzle openings are lined in a second direction perpendicular to the first direction, and the head main bodies are relatively positioned and fixed, the head main bodies are provided with a first positioning hole and a second positioning hole to which positioning pins are inserted, and intervals between the first positioning holes of each head main body is shorter than lengths of the nozzle rows of the head main bodies.

### BACKGROUND

1. Technical Field

The present invention relates to a liquid ejecting head and a liquid ejecting apparatus configured to eject a liquid from nozzle openings. Particularly, the invention relates to an ink jet type recording head and an ink jet type recording apparatus configured to discharge an ink as the liquid.

2. Related Art

A liquid ejecting apparatus represented by an ink jet type recording apparatus such as an ink jet type printer and a plotter includes a liquid ejecting head capable of ejecting a liquid such as ink stored in a cartridge, a tank or the like as a liquid droplet.

In the liquid ejecting head used in the liquid ejecting apparatus, it is difficult to lengthen the nozzle openings (multi-nozzles) automatically to perform high density printing, since the liquid ejecting head increases in size, yield decreases, and the manufacturing cost becomes expensive. For this reason, a liquid ejecting head has been suggested in which a plurality of head main bodies is fixed to a common fixing member to become a unit (for example, see JP-A-2010-30230).

However, there have been the following problems. The fixing member, to which the plurality of head main bodies is fixed, is expanded or contracted due to the change of the temperature and the humidity, positioning pins provided in the fixing member and inserted to positioning holes of the head main bodies moves the head main bodies, and a relative position of the plurality of head main bodies deviates.

Moreover, there has been the following problem. When an amount of deviation of the relative position of the head main bodies increases, in a case where the nozzle rows are lengthened in the plurality of head main bodies, stripes occurs on a medium to be recorded at a joint between the two head main bodies, and thus the printing quality is degraded.

In addition, such problems similarly exist in the liquid ejecting head configured to eject a liquid other than ink as well as the ink jet type recording head.

### SUMMARY

An advantage of some aspects of the invention is to provide a liquid ejecting head and a liquid ejecting apparatus capable of suppressing the recording failure to the medium to be recorded due to the change of the temperature and the humidity.

According to an aspect of the invention, there is provided a liquid ejecting head that includes head main bodies having nozzle rows in which nozzle openings configured to eject a liquid are arranged; and a fixing member in which rows of the head main bodies arranged in a first direction as an arrangement direction of the nozzle openings are lined in a second direction perpendicular to the first direction, and the head main bodies are relatively positioned and fixed, wherein the head main bodies are provided with a first positioning hole and a second positioning hole to which positioning pins are inserted, the first positioning hole regulates the movement of the head main bodies with respect to the fixing member in the first direction as an arrangement direction of the nozzle openings and the second direction perpendicular to the first direction, the second positioning hole regulates the movement of the head main bodies around the first positioning hole with respect to the fixing member in a rotary direction, and intervals between the first positioning holes of each head main body are shorter than a length of the nozzle rows of the head main bodies.

In such an aspect, by setting the interval of the first positioning holes of the head main bodies adjacent to each other in the first direction to be shorter than the nozzle rows, even if the fixing member is expanded or contracted due to temperature changes and environmental changes and the head main bodies are moved by the positioning pins, it is possible to reduce an amount of movement between the head main bodies adjacent to each other in the first direction.

Herein, in a plurality of head main bodies, it is preferable that all the positions of the first positioning hole and the second positioning hole with respect to the nozzle openings be provided at the same position. According to this configuration, since the head main bodies of the same standard can be used, the manufacturing cost can be reduced, and the cost for managing the different kinds of head main bodies can be reduced.

Furthermore, it is preferable that all the intervals of the first positioning holes of the head main bodies adjacent to each other in the first direction be provided at the uniform intervals. According to this configuration, even if the fixing member is expanded or contracted due to temperature changes and environmental changes and the head main bodies are moved by the positioning pins, it is possible to equalize the amount of movement between the head main bodies adjacent to each other in the first direction.

Furthermore, it is preferable that, in the head main bodies that are arranged in the first direction to form a row, the first positioning hole and the second positioning hole be provided on the same side in the second direction, and the rows of the head main bodies arranged in the second direction be the head main bodies provided at the opposite positions of the first positioning hole and the second positioning hole in the second direction. According to this configuration, the printing quality can be improved because it is possible to shorten the intervals of the nozzle rows provided at the different positions in the second direction, and it is possible to reduce an occurrence of the difference in timing when the liquid droplet ejected from the different nozzle rows in the second direction impacts on the medium to be recorded, and it is possible to suppress the color difference and an occurrence of a stripe due to the difference in an amount of bleeding of the liquid droplet to the medium to be recorded.

Furthermore, it is preferable that the first positioning hole be provided on one end portion side of the head main bodies in the first direction, the second positioning hole be provided on the other end portion side thereof, and the two head main bodies adjacent to each other in the first direction be provided so that the one end portion side provided with the first positioning hole of one head main body, and the one end portion side provided with the first positioning hole of the other head main body or the other end portion side provided with the second positioning hole be at the same position in the first direction. According to this configuration, it is possible to relatively and accurately position the head main bodies in the fixing member using two positioning holes separated from each other, and even if the fixing member is expanded or contracted due to temperature changes and environmental changes and the head main bodies are moved by the positioning pins, it is possible to reduce the amount of movement between the head main bodies adjacent to each other in the first direction.

In addition, according to another aspect of the invention, there is provided a liquid ejecting apparatus that includes the liquid ejecting head of the above-mentioned aspects.

In this aspect, it is possible to realize the liquid ejecting apparatus in which the difference in the impact position of the liquid droplet to the medium to be recorded is suppressed.

### BRIEF DESCRIPTION OF THE DRAWINGS

The invention will be described with reference to the accompanying drawings, wherein like numbers reference like elements.

FIG. 1 is an exploded perspective view of a recording head related to Embodiment 1.

FIG. 2 is a plan view of the recording head related to Embodiment 1.

FIG. 3 is a cross-sectional view of the recording head related to Embodiment 1.

FIG. 4 is an exploded perspective view of a head main body related to Embodiment 1.

FIG. 5 is a plan view of the head main body related to Embodiment 1.

FIG. 6 is a cross-sectional view of the head main body related to Embodiment 1.

FIG. 7 is a plan view of a recording head of a comparative example.

FIG. 8 is a plan view of a recording head related to Embodiment 2.

FIG. 9 is a schematic view of a recording apparatus related to an embodiment.

### DESCRIPTION OF EXEMPLARY EMBODIMENTS

Hereinafter, the invention will be described in detail based on the embodiments.

### Embodiment 1

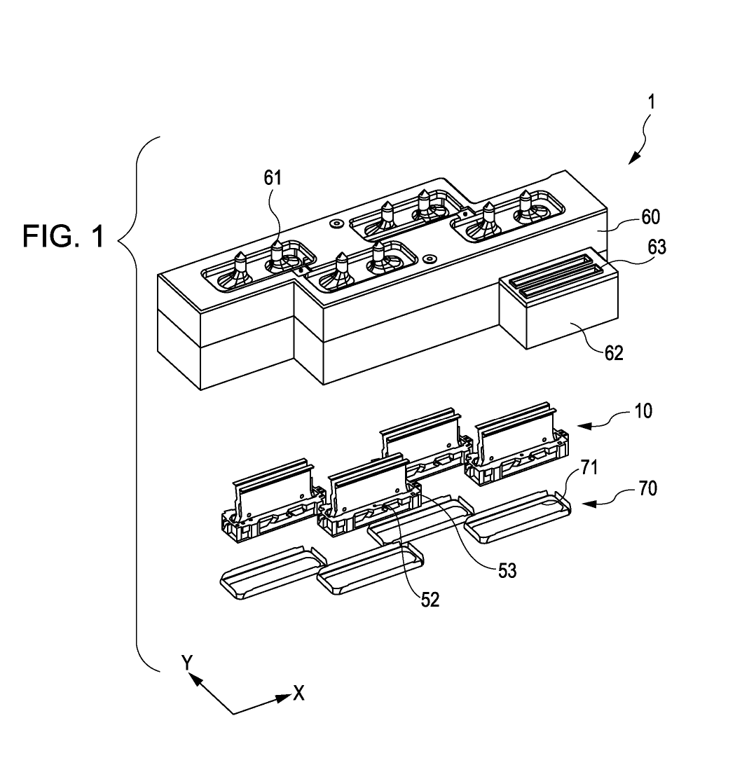

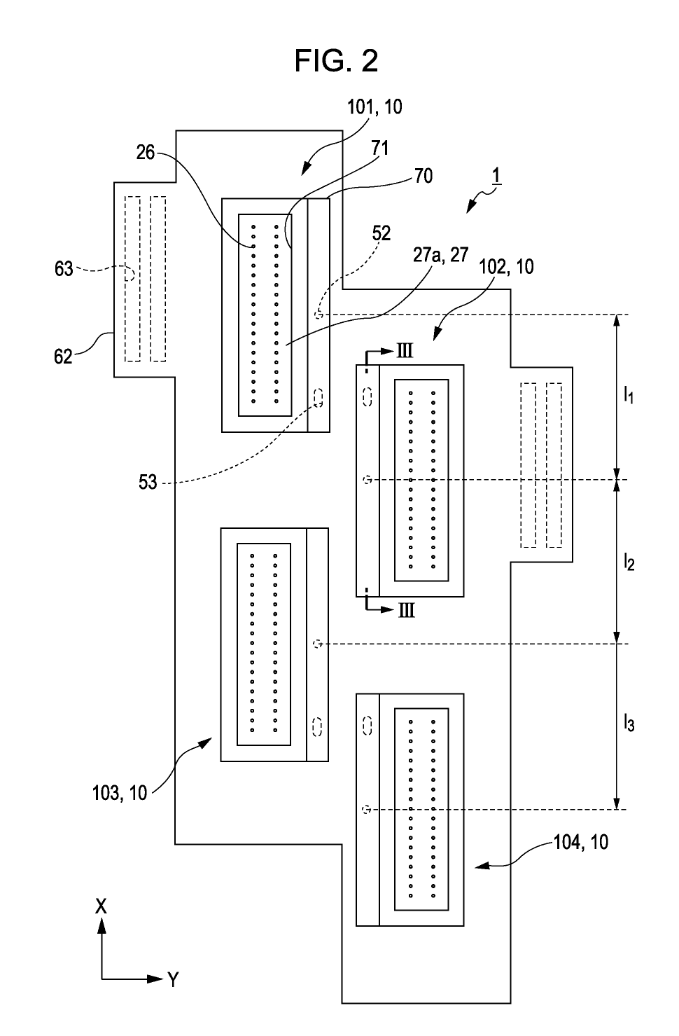

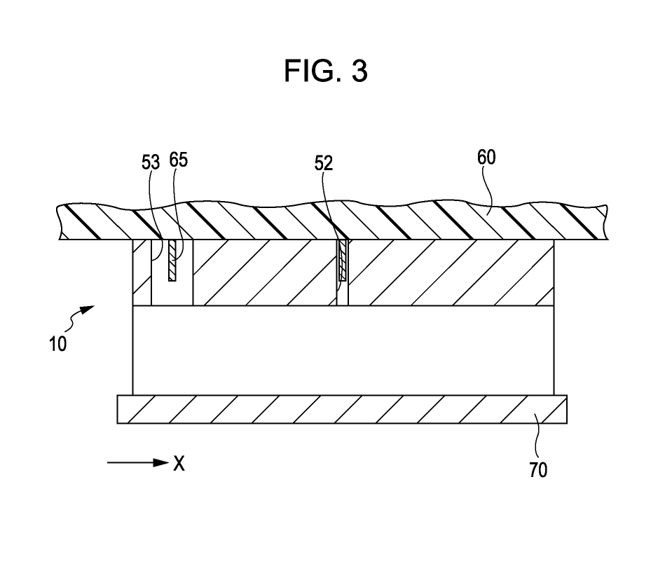

FIG. 1 is an exploded perspective view that shows an ink jet type recording head that is an example of a liquid ejecting head related to Embodiment 1 of the invention, FIG. 2 is a plan view from a liquid ejecting surface side of the ink jet type recording head, and FIG. 3 is a cross-sectional view taken from line III-III of FIG. 2 that shows a schematic configuration of the ink jet type recording head.

As shown, an ink jet type recording head 1 includes a plurality (as an example, four in the present example) of head main bodies 10 as an example of liquid ejecting heads, and a fixing member 60.

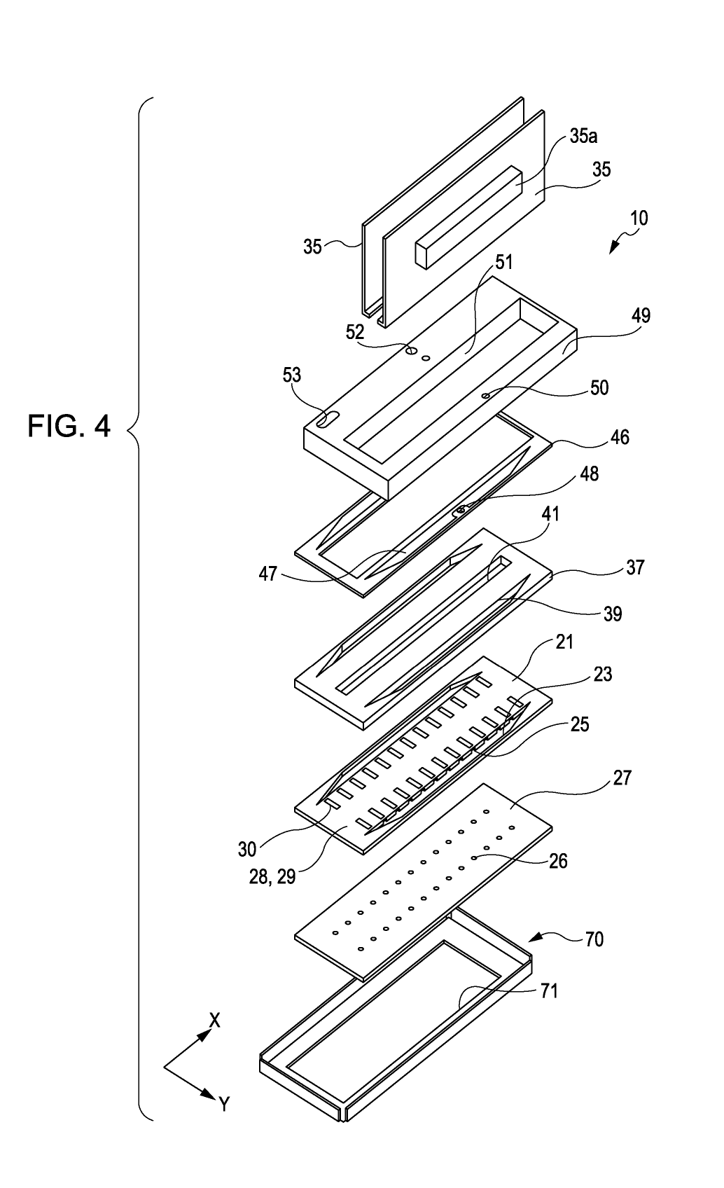

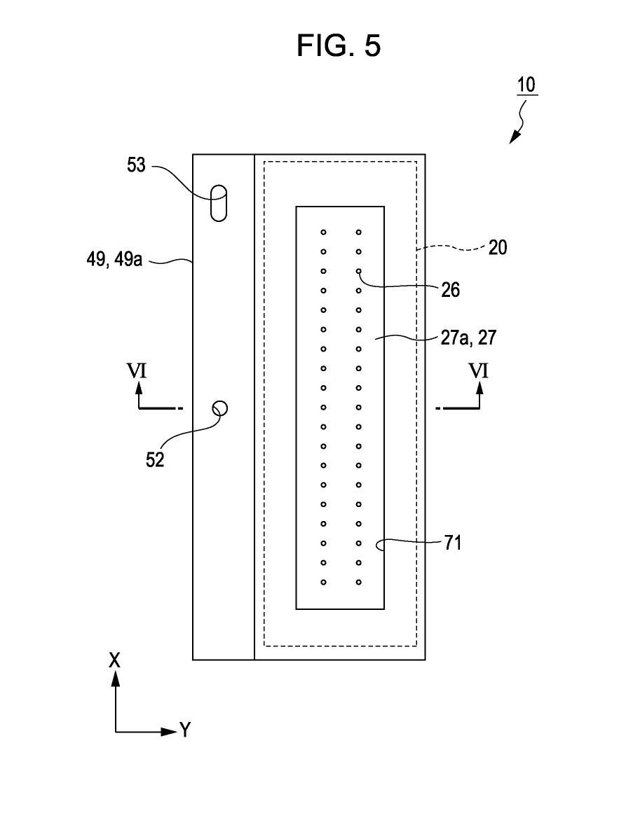

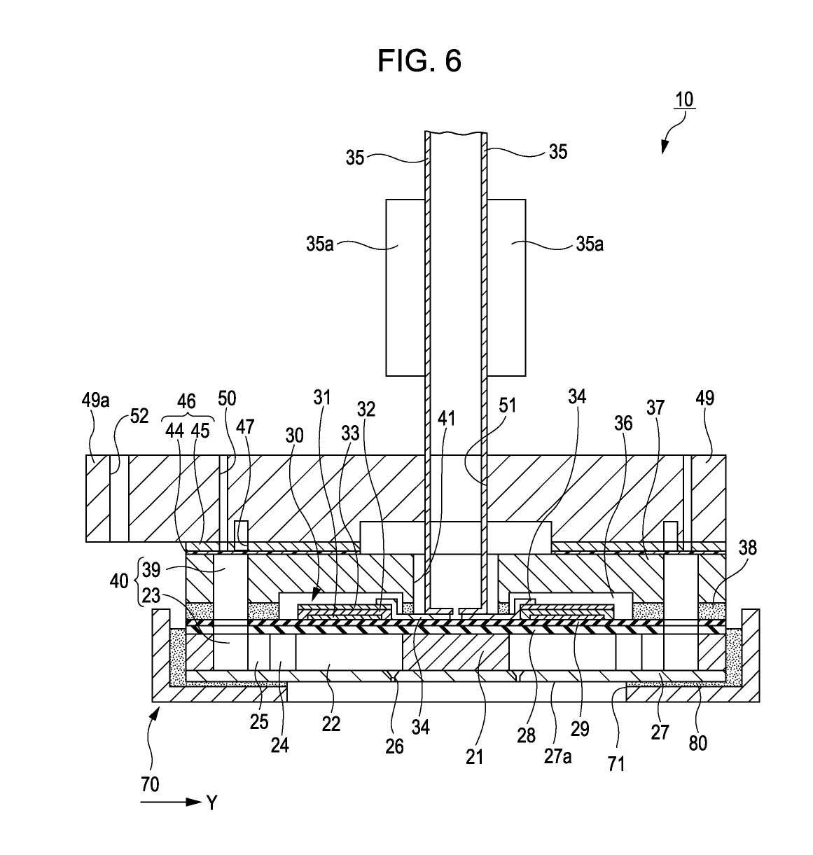

First, an example of the configuration of the head main body 10 of the embodiment will be described with reference to FIGS. 4 to 6. In addition, FIG. 4 is an exploded perspective view of the head main body related to Embodiment 1 of the invention, FIG. 5 is a plan view from the liquid ejecting surface side of the head main body, and FIG. 6 is a cross-sectional view taken from line VI-VI of FIG. 5.

As shown, in a flow path forming substrate 21 forming the head main body 10, rows of a plurality of pressure generation chambers 22 arranged in a first direction X as an arrangement direction of nozzle openings 26 are provided in two lines in a second direction Y perpendicular to the first direction. Furthermore, in an external area in the second direction Y of the pressure generation chamber 22 of each row, a communication portion 23 is formed, and the communication portion 23 communicates with each pressure generation chamber 22 via ink supply paths 24 and communication paths 25 provided for each pressure generation chamber 22.

A nozzle plate 27 drilled with the nozzle openings 26 communicating with the vicinity of the end portion of each pressure generation chamber 22 of an opposite side of the ink supply path 24 is joined to one surface of the flow path forming substrate 21.

Furthermore, a cover head 70 provided with an exposure opening portion 71 for exposing the nozzle openings 26 is fixed to a liquid ejecting surface 27a side of the nozzle plate 27 of the head main body 10 through which the nozzle openings 26 are opened.

The cover head 70 has a box shape formed by bending and raising edge portions of a rectangular plate-like member to the side surface side of the head main body 10, and a bottom surface thereof is joined to a surface of the nozzle plate 27 as the liquid ejecting surface 27a via an adhesive 80.

Meanwhile, on a surface of the flow path forming substrate 21 of an opposite side of the nozzle plate 27, a piezoelectric actuator 30 is formed via an elastic film 28 and an insulator film 29. The piezoelectric actuator 30 includes a first electrode 31, a piezoelectric layer 32 formed of a piezoelectric material representing an electro mechanical conversion function, and a second electrode 33. A lead electrode 34 extended up to the top of the insulator film 29 is connected to a second electrode 33 forming each piezoelectric actuator 30. One end portion of the lead electrode 34 is connected to the second electrode 33, and the other end portion side thereof is connected to a driving wiring 35 that is a flexible wiring member (a COF substrate) and is mounted with a driving IC 35a for driving the piezoelectric actuator 30 thereon.

On the flow path forming substrate 21 formed with such a piezoelectric actuator 30, in an area facing the piezoelectric actuator 30, a protective substrate 37 including a piezoelectric actuator holding portion 36 as a space for protecting the piezoelectric actuator 30 is bonded by the adhesive 38. Furthermore, the protective substrate 37 is provided with a manifold portion 39. In the embodiment, the manifold portion 39 constitutes a manifold 40 that communicates with the communication portion 23 of the flow path forming substrate 21 and becomes a common ink chamber of each pressure generation chamber 22.

Furthermore, the protective substrate 37 is provided with a through hole 41 that penetrates the protective substrate 37 in a thickness direction. In the embodiment, the through hole 41 is provided between two piezoelectric actuator holding portions 36. Moreover, the vicinity of the end portion of the lead electrode 34 drawn from each piezoelectric actuator 30 is provided so as to be exposed in the through hole 41.

Furthermore, a compliance substrate 46 including a sealing film 44 and a fixing plate 45 is bonded onto the protective substrate 37. Herein, the sealing film 44 is made of a material having flexibility with low rigidity, and one surface of the manifold portion 39 is sealed by the sealing film 44. Furthermore, the fixing plate 45 is formed of a hard material such as a metal. Since an area of the fixing plate 45 facing the manifold 40 is an opening portion 47 that is completely removed in the thickness direction, the one surface of the manifold 40 is sealed only by the sealing film 44 having flexibility. The compliance is applied into the manifold 40 in the area sealed only by the sealing film 44. Moreover, the compliance substrate 46 is provided with an ink introduction port 48 for introducing the ink into the manifold 40.

A head case 49 as a case member is fixed onto the compliance substrate 46.

The head case 49 is provided with an ink introduction path 50 that communicates with the ink introduction port 48 to supply the manifold 40 with the ink from a storage unit such as a cartridge. Furthermore, the head case 49 is provided with a wiring member holding hole 51 that communicates with the through hole 41 provided in the protective substrate 37, and one end side of the driving wiring 35 is connected to the lead electrode 34 in a state of being inserted into the wiring member holding hole 51.

In addition, the head case 49 has a projection portion that is projected from one side in the second direction Y. Moreover, the projection portion is provided with a first positioning hole 52 and a second positioning hole 53 for positioning the head main body in the fixing member so that the holes penetrate in the thickness direction (a laminating direction of the flow path forming substrate 21 and the head case 49).

Herein, although the details will be described later, the first positioning hole 52 and the second positioning hole 53 are used when positioning the relative position of the plurality of head main bodies 10 by positioning the head main bodies 10 in the fixing member 60.

Moreover, the first positioning hole 52 has a single hole, that is, an original circle or an opening shape similar to the original circle so that the movement of the head main bodies 10 in the first direction X and the second direction Y is regulated by the insertion of a positioning pin 65 of the fixing member 60, the details of which will be described later. In the embodiment, such the first positioning hole 52 is provided inside the two nozzle rows with the nozzle openings 26 arranged therein in the second direction Y, and in the central portion of the nozzles rows in the first direction X. In addition, the expression that the first positioning hole 52 is provided inside the two nozzle rows in the second direction Y means that, although the details thereof will be described later, in the head main bodies 10 arranged in the first direction X, the first positioning hole 52 of one head main body 10 is placed on the other head main body 10 side rather than the nozzle opening 26. Furthermore, in the expression that the first positioning hole 52 is provided in the central portion of the nozzle rows in the first direction X, in the embodiment, since the nozzle rows are placed in the head main bodies 10 at an equal layout in the first direction X, the first positioning hole 52 is provided in the central portion of the head main body 10 in the first direction X.

Furthermore, the second positioning hole 53 has a long opening that is long in the first direction X, that is, an oval opening shape or almost an oval opening shape in which the first direction X becomes a major axis so that the movement around (a shaft of) the first positioning hole 52 in a rotary direction is regulated by the insertion of the positioning pins 65 of the fixing member 60. The second positioning hole 53 is provided at the same position as the first positioning hole 52 in the second direction Y, and on the one end portion side of the head main body 10 in the first direction X. In this manner, by forming the second positioning hole 53 by the long hole, even if an error during manufacturing occurs at the positions of the first positioning hole 52 and the second positioning hole 53, and at the positions of the positioning pins 65 of the fixing member 60, the positioning pins 65 can be reliably inserted to the second positioning holes, and the head main body 10 can be positioned with respect to the fixing member 60.

In the head main body 10 of the embodiment, the ink from a storage unit (not shown) is taken from the ink introduction port 48 via the fixing member 60, the inside from the manifold 40 to the nozzle opening 26 is filled with the ink, then the voltage is applied to the respective piezoelectric actuators 30 corresponding to the pressure generation chamber 22 depending on the recording signal from the driving IC 35a, and the elastic film 28, the insulator film 29 and the piezoelectric actuator 30 are subjected to the bending deformation. Thus, the pressure in each pressure generation chamber 22 increases and the ink droplet is discharged from the nozzle opening 26.

Moreover, a plurality of head main bodies 10, in the embodiment, four head main bodies 10 are fixed to the one surface of the fixing member 60. Herein, returning to FIGS. 1 to 3, the fixing member 60 will be described in detail.

For example, the fixing member 60 includes a flow path member that is formed of a resin material and is formed with a circuit board and an ink communication path therein, a filter for removing garbage and air bubbles or the like. Furthermore, ink supply needles 61 (in the present example, for example, eight) are fixed onto an upper surface (a surface of an opposite side of the surface to which the head main body 10 is fixed) of the fixing member 60. The liquid storage unit (not shown) storing each color ink is connected to the ink supply needles 61 directly or via the tube. Furthermore, one end of an ink communication path (not shown) communicates with the ink supply needle 61. In addition, the other end of the ink communication path is opened to the head main body 10 side (a lower surface side of the fixing member 60). That is, the ink from the liquid storage unit is supplied to the ink communication path via the ink supply needles 61, and the supplied ink is supplied to the head main body 10 via the ink introduction path, respectively.

The head main bodies 10 held in the fixing member 60 is able to form the long nozzle row in the first direction X at the same pitch by being placed in a zigzag manner toward the first direction X as the arrangement direction of the nozzle openings 26. In addition, the expression that the head main bodies 10 are placed in a zigzag manner means that the plurality of head main bodies 10 is arranged toward the first direction X as the arrangement direction of the nozzle openings 26 (see FIG. 2), and the plurality of rows arranged in the first direction X, in the embodiment, the rows constituted by the two head main bodies 10 are arranged in two lines in the second direction Y perpendicular to the direction (the first direction X) in which the nozzle openings 26 are arranged. The two rows of the head main bodies 10 arranged in the second direction Y are placed at the positions that are each slightly shifted toward the first direction X. Moreover, in the rows of the head main bodies 10 of the two rows, the head main bodies 10 adjacent to each other are installed so that the nozzle opening 26 of the end portion side of the nozzle row of the head main body 10 of the one row and the nozzle opening 26 of the end portion side of the nozzle row of the head main body 10 of the other row are located at the same position in the first direction X of the nozzle opening 26. Thereby, the nozzle openings 26 can be arranged as much as the four head main bodies 10 along the first direction X at the same pitch by the plurality of head main bodies 10 (in the embodiment, four head main bodies 10) to cause the nozzle rows to continue. Thus, printing can be performed over a wide area by the width of the continuous nozzle row.

In addition, the fixing member 60 has a shape in which the corner portions becoming a pair of opposite angles are notched on the basis of the rectangular shape when viewed from the upper surface. In addition, the expression that the fixing member 60 has the rectangular shape and the corner portions becoming the pair of opposite angles have the notched shape specifically refers to the following structure. In each of the each end portion of the fixing member 60 in the longitudinal direction, a convex portion and a concave portion having the rectangular shape when viewed from the upper surface are arranged in the transverse direction. Moreover, in each end portion of the fixing member 60 in the longitudinal direction, the convex portion and the concave portion are provided so that the convex portion and the concave portion are oppositely placed. The concave portion has a shape in which the corner portions becoming the above-mentioned pair of opposite angles are notched.

Moreover, the two rows of the head main bodies 10 arranged in the second direction Y are placed at the positions that are each slightly shifted to the convex portion side toward the first direction X so that the head main bodies 10 are placed in the convex portion that is projected to both sides of the fixing member 60 in the longitudinal direction.

Furthermore, the fixing member 60 has an extension portion 62 in which a part of a long side thereof is extended to both sides of a short side in a plane direction. That is, the fixing member 60 has the extension portion 62 that is extended to both sides in the transverse direction. Although not particularly shown, a connector of the circuit board provided inside is placed in the extension portion 62, and an external wiring is connected to the connector of the circuit board through a slit 63 provided on the upper surface of the extension portion 62. In addition, a driving wiring 35 described later of the plurality of head main bodies 10 is commonly connected to the circuit board.

Furthermore, on the surface of the fixing member 60 to which the head main bodies 10 are fixed, the positioning pins 65 inserted to the first positioning hole 52 and the second positioning hole 53 of the head main bodies 10 are projected and provided. In the embodiment, since the two positioning holes (the first positioning hole 52 and the second positioning hole 53) are provided in one head main body 10, the two positioning pins 65 for each head main body 10, that is, total eight positioning pins 65 are provided.

Moreover, by inserting the positioning pins 65 to the first positioning hole 52 and the second positioning hole 53 of the head main body 10, the plurality of head main bodies 10 is positioned so that the position of the nozzle opening 26 becomes the relative position.

Herein, the arrangement of the plurality of head main bodies 10 fixed to the fixing member 60 of the embodiment will be described with reference to FIG. 2 while referring the four head main bodies 10 as a first head main body 101 to a fourth head main body 104, respectively.

In the embodiment, the first head main body 101 to the fourth head main body 104 are the head main bodies 10 of the same standard in which the first positioning hole 52 and the second positioning hole 53 are placed at the same position.

The first head main body 101 and the third head main body 103 are placed at the same position in the second direction Y at the same angle (an in-plane rotary angle of the first direction X and the second direction Y).

On the contrary, the second head main body 102 and the fourth head main body 104 are placed at the same position in the second direction Y at the same angle (an in-plane rotary angle of the first direction X and the second direction Y).

Moreover, the first head main body 101 and the third head main body 103 are placed so that the first directions X thereof are located at the different positions, and the second head main body 102 and the fourth head main body 104 are placed so that the first directions X thereof are located at the different positions.

Furthermore, the second head main body 102 and the fourth head main body 104 are placed in a state of being rotated by 180° with respect to the first head main body 101 and the third head main body 103 in the planes of the first direction X and the second direction Y.

Thereby, the end portion, in which the second positioning hole 53 of the first head main body 101 is provided, and the end portion side of an opposite side of the end portion, in which the second positioning hole 53 of the second head main body 102 is provided, is placed so that the nozzle rows continue in the first direction X. That is, the end portion side in which the second positioning hole 53 of the first head main body 101 is provided, and the end portion side of an opposite side of the second positioning hole 53 of the second head main body 102 are placed so that the end portion sides are located at the same position in the first direction X. In other words, the end portion in which the second positioning hole 53 of the first head main body 101 is provided, and the end portion of an opposite side of the second positioning hole 53 of the second head main body 102 face each other in the second direction Y, and the nozzle rows are placed so as to continue in the first direction X. For this reason, an interval l₁ between the first positioning hole 52 of the first head main body 101 and the first positioning hole 52 of the second head main body 102 in the first direction X is equal to or less than the length of the nozzle row of one head main body 10.

Similarly, the end portion, in which the second positioning hole 53 of the second head main body 102 is provided, and the end portion side of an opposite side of the end portion, in which the second positioning hole 53 of the third head main body 103 is provided, is placed so that the nozzle rows continue in the first direction X. For this reason, an interval l₂ between the first positioning hole 52 of the second head main body 102 and the first positioning hole 52 of the third head main body 103 in the first direction X is equal to or less than the length of the nozzle row of one head main body 10.

Furthermore, similarly, the end portion, in which the second positioning hole 53 of the third head main body 103 is provided, and the end portion side of an opposite side of the end portion, in which the second positioning hole 53 of the fourth head main body 104 is provided, is placed so that the nozzle rows continue in the first direction X. For this reason, an interval l₃ between the first positioning hole 52 of the third head main body 103 and the first positioning hole 52 of the fourth head main body 104 in the first direction X is equal to or less than the length of the nozzle row of one head main body 10.

That is, in the embodiment, since the first positioning hole 52 is provided in the central portion of the nozzle rows of the head main bodies 10 in the first direction X as mentioned above, the intervals l₁, l₂ and l₃ of the first positioning holes 52 of two head main bodies 10 adjacent to each other in the first direction X are equal to or less than the lengths of the nozzle rows, respectively. In addition, the head main bodies 10 adjacent to each other in the first direction X means that the nozzle rows are placed so as to be adjacent to each other in the first direction X among the head main bodies 10 so that the nozzle rows are placed so as to continue in the first direction X.

In this manner, since the intervals l₁, l₂ and l₃ of the head main bodies 10 adjacent to each other in the first direction X can be set to be equal to or less than the length of the nozzle row, when the fixing member 60 is expanded or contracted due to temperature changes and humidity changes, an amount of deviation of the relative position of the head main bodies 10 can be reduced. Thereby, when the ink droplet discharged from the nozzle rows continued in the first direction X impacts on the medium to be recorded, it is possible to suppress an occurrence of a stripe at a joint of the nozzle rows adjacent to each other in the first direction X.

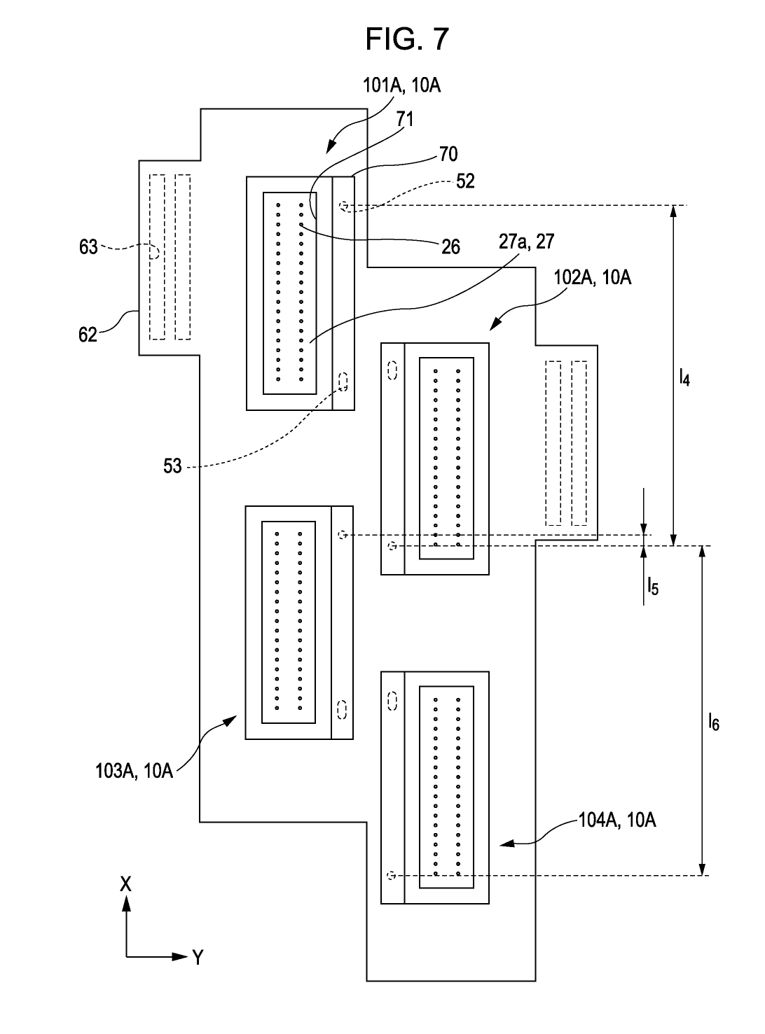

Herein, for comparison, when using the head main body 10A in which the first positioning hole 52 provided at one end portion side in the first direction X and the second positioning hole 53 is provided at the other end portion side in the first direction X, the arrangement of the head main body 10A will be described with reference to FIG. 7. In addition, FIG. 7 is a plan view from the nozzle opening side that shows a comparative ink jet type recording head. Furthermore, an example shown in FIG. 7 will be described while referring the four head main bodies 10A as a first head main body 101A to a fourth head main body 104A, respectively.

In an example shown in FIG. 7, the first head main body 101A to the fourth head main body 104A are the head main bodies 10A of the same standard in which the first positioning hole 52 and the second positioning hole 53 are placed at the same position.

The first head main body 101A and the third head main body 103A are placed at the same position in the second direction Y at the same angle (an in-plane rotary angle of the first direction X and the second direction Y).

On the contrary, the second head main body 102A and the fourth head main body 104A are placed at the same position in the second direction Y at the same angle (an in-plane rotary angle of the first direction X and the second direction Y).

Moreover, the first head main body 101A and the third head main body 103A are placed so that the first directions X thereof are located at the different positions, and the second head main body 102A and the fourth head main body 104A are placed so that the first directions X thereof are located at the different positions.

Furthermore, the second head main body 102A and the fourth head main body 104A are placed in a state of being rotated by 180° with respect to the first head main body 101A and the third head main body 103A in the planes of the first direction X and the second direction Y.

That is, the first head main body 101A to the fourth head main body 104A are placed in the same direction as those of the first head main body 101 to the fourth head main body 104 shown in FIG. 2.

For this reason, the head main body 10A in which the nozzle rows continue in the first direction X is placed so that the end portions, in which the first positioning hole 52 is provided, and the end portions in which the second positioning hole 53 is provided, face each other in the second direction Y.

Thus, the interval l₄ between the first positioning hole 52 of the first head main body 101A and the first positioning hole 52 of the second head main body 102A becomes longer than the length (the length in the first direction X) of the nozzle row of one head main body 10A and becomes a length of about twice the nozzle row.

Furthermore, since the second head main body 102A and the third head main body 103A are placed so that the end portions in which the first positioning hole 52 is provided face each other in the second direction Y, an interval l₅ between the first positioning hole 52 of the second head main body 102A and the first positioning hole 52 of the third head main body 103A becomes shorter than the length of the nozzle row.

Similarly, an interval l₆ between the first positioning hole 52 of the third head main body 103A and the first positioning hole 52 of the fourth head main body 104A becomes longer than the length (the length in the first direction X) of the nozzle row of one head main body 10A and becomes a length of about twice the nozzle row.

For example, in the case of the head main body 10A having the length (the first direction X) of the nozzle row of 1 inch, the intervals l₄ and l₆ are about 2 inches.

In this manner, if the intervals l₄ and l₆ of the first positioning holes of the head main bodies 10A adjacent to each other in the first direction X are widened, when the fixing member 60 is expanded or contracted due to temperature changes and humidity changes, the positioning pin 65 of the fixing member 60 moves the head main body 10A via the first positioning pin 52, and the positions of the nozzle rows of the two head main bodies 10A greatly deviate. For example, as in the comparative example, when the intervals l₄ and l₆ of the first positioning hole are 2 inches and the expansion coefficient of the fixing member 60 is 0.1%, the amount of deviation of the two first positioning holes 52 is 2 inches×25.4 mm×0.1%=50.8 μm. In this manner, the great deviation of the intervals l₄ and l₆ of the first positioning hole 52 of the two head main bodies 10A means that the nozzle rows of the head main bodies 10A moved by the positioning pin 65 deviate by the same interval (50.8 μm). Thus, when performing the printing using this ink jet type recording head, the stripe due to the position deviation occurs at the joint of the nozzle rows.

In this embodiment, as shown in FIG. 2, when the length of the nozzle row is 1 inch, the intervals l₁ to l₃ of the two head main bodies 10 are equal to or less than 1 inch. For this reason, when the intervals l₁ to l₃ of the first positioning hole 52 are 1 inch, and the expansion coefficient of the fixing member 60 is 0.1%, the amount of deviation of the two first positioning holes 52 is reduced to 1 inch×25.4 mm×0.1%=25.4 μm.

That is, in the ink jet type recording head of the comparative example, for example, although the interval l₅ between the third head main bodies 103A adjacent to each other on one side of the second head main body 102A in the first direction X due to the temperature change is nearly widened (shrunk) due to the deviation, the interval l₄ of the first head main bodies 101A adjacent to each other on the other side in the first direction X with respect to the second head main body 102A greatly deviates by 50.8 μm. On the contrary, in the ink jet type recording head 1 of the embodiment, the intervals l₁ and l₂ between the first head main body 101 and the third head main body 103 on both sides in the first direction X each deviate by 25.4 μm with respect to the second head main body 102 due to the temperature change. That is, in the ink jet type recording head of the comparative example, in the intervals between one head main body 10A and both head main bodies 10A, one interval does not nearly deviate, and the other interval greatly deviates. Meanwhile, in the ink jet type recording head 1 of the embodiment, the intervals between the one head main body 10 and both head main bodies 10 each deviate so as to be equally allocated. Thus, when the ink jet type recording head 1 of the embodiment performs printing on the medium to be recorded, it is possible to suppress an occurrence of a stripe at the joint of the nozzle rows of the head main bodies 10.

Furthermore, in the embodiment, since all the intervals of the first positioning holes 52 of the head main bodies 10 adjacent to each other in the first direction X are placed so as to be the equal interval, the amount of deviation between all the head main bodies 10 can be equalized. Thereby, it is also possible to suppress an occurrence of a stripe at the joint of the nozzle rows.

In addition, in the embodiment, the head main bodies 10 of the same standard in which the first positioning hole 52 and the second positioning hole 53 are provided at the same position are used for the ink jet type recording head 1. For this reason, compared to a case of using the plurality of head main bodies of different standards, the manufacturing cost can be reduced, the labor for managing the head main bodies for each standard can be excluded, and thus the cost can be reduced.

Furthermore, as shown in FIG. 2, in the plurality of head main bodies 10 held in the fixing member 60, the rows constituted by the plurality of (two) head main bodies 10 arranged in the first direction X are arranged in two lines in the second direction Y intersecting with the direction (the first direction X) in which the nozzle openings 26 are arranged. At this time, the head main bodies 10 adjacent to each other in the second direction Y are placed so that the surfaces (long sides), on which the first positioning hole 52 and the second positioning hole 53 are provided, face each other. Thereby, it is possible to reduce the distances of the first positioning hole 52 and the second positioning hole 53 in the first direction X of the head main bodies 10 (for example, the first head main body 101 and the second head main body 102) adjacent to each other in the second direction Y, and thus the position deviation of the two first positioning holes 52 is difficult to occur. In addition, when placing the surfaces (the long sides) of a side opposite to the surface (the long side) in which the first positioning hole 52 and the second positioning hole 53 are provided so as to face each other, the distances of the first positioning hole 52 and the second positioning hole 53 in the first direction X of the head main bodies 10 adjacent to each other in the first direction X become longer, and thus an error such as the position deviation easily occurs.

### Embodiment 2

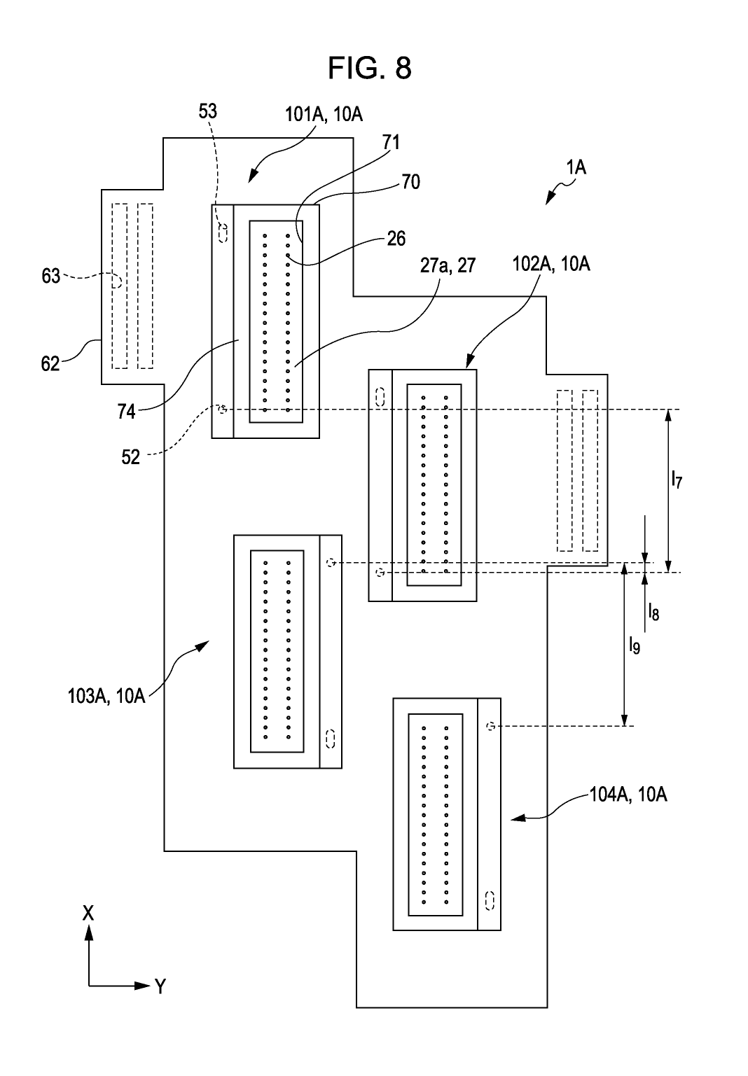

FIG. 8 is a plan view of a liquid ejecting surface side of an ink jet type recording head that is an example of a liquid ejecting head related to Embodiment 2 of the invention. In addition, the same members as those of the above-mentioned Embodiment 1 are denoted by the same reference numerals, and the repeated descriptions thereof will be omitted.

As illustrated in FIG. 8, an ink jet type recording head 1A as an example of the liquid ejecting head of the embodiment includes a plurality of head main bodies 10A and a fixing member 60.

As illustrated, in the embodiment, the head main body 10A is configured so that the first positioning hole 52 is provided on one end portion side in the first direction X and the second positioning hole 53 is provided on the other end portion side in the first direction X.

Four head main bodies 10A are fixed to the fixing member 60. Herein, a specific arrangement of the head main body 10A of the embodiment will be described with reference to FIG. 8 while referring the four head main bodies 10A as a first head main body 101A to a fourth head main body 104A, respectively.

In the embodiment, the first head main body 101A to the fourth head main body 104A are the head main bodies 10A of the same standard in which all the first positioning hole 52 and the second positioning hole 53 are placed at the same position.

The first head main body 101A and the second head main body 102A are placed at the same angle (an in-plane rotary angle of the first direction X and the second direction Y).

Furthermore, the third head main body 103A and the fourth head main body 104A are placed at the same angle (an in-plane rotary angle of the first direction X and the second direction Y).

Moreover, the third head main body 103A and the fourth head main body 104A are placed in a state of being rotated by 180° with respect to the first head main body 101A and the second head main body 102A in the planes of the first direction X and the second direction Y.

Herein, the end portion of the first head main body 101A in which the first positioning hole 52 is provided, and the end portion of the second head main body 102A in which the second positioning hole 53 is provided are provided so that the nozzle rows continue in the first direction X. That is, the end portion side of the first head main body 101A in which the first positioning hole 52 is provided, and the end portion side of the second head main body 102A in which the second positioning hole 53 is provided are provided so as to be located at the same position in the first direction X. In other words, the end portion of the first head main body 101A in which the first positioning hole 52 is provided, and the end portion of the second head main body 102A in which the second positioning hole 53 is provided face each other in the second direction Y, and the nozzle rows are placed so as to continue in the first direction X. For this reason, an interval l₇ between the first positioning hole 52 of the first head main body 101A and the first positioning hole 52 of the second head main body 102A in the first direction X is equal to or less than the length of the nozzle row of one head main body 10A.

Similarly, the end portion of the second head main body 102A in which the first positioning hole 52 is provided, and the end portion of the third head main body 103A, in which the first positioning hole 52 is provided, are placed so that the nozzle rows continue in the first direction X. For this reason, an interval l₈ between the first positioning hole 52 of the second head main body 102A and the first positioning hole 52 of the third head main body 103A in the first direction X is equal to or less than the length of the nozzle row of one head main body 10A and is shorter than the interval l₇.

In addition, the end portion of the third head main body 103A in which the second positioning hole 53 is provided, and the end portion of the fourth head main body 104A, in which the first positioning hole 52 is provided, are placed so that the nozzle rows continue in the first direction X. For this reason, an interval l₉ between the first positioning hole 52 of the third head main body 103A and the first positioning hole 52 of the fourth head main body 104A in the first direction X is equal to or less than the length of the nozzle row of one head main body 10A.

That is, in the embodiment, the two head main bodies 10A fixed to the fixing member 60 and adjacent to each other in the first direction X are placed so that the one end portion side of one head main body 10A in which the first positioning hole 52 is provided, and the one end portion side of the other head main body 10A in which the first positioning hole 52 is provided, or the other end portion side, in which the second positioning hole 53 is provided, are located at the same position in the first direction X. That is, in the head main body 10A in which the nozzle rows are arranged so as to continue in the first direction X, the end portion in which the nozzle rows continue is any one of a combination of the end portions in which the first positioning hole 52 is provided, or a combination of the end portions in which the first positioning hole 52 is provided and the end portions in which the second positioning hole 53 is provided. Accordingly, the nozzle rows are not continuously located between the end portions in which the second positioning hole 53 is provided.

With such a configuration, the intervals l₇ to l₉ between the head main bodies 10A adjacent to each other in the first direction X can be set to be shorter than the length of the nozzle row of one head main body 10A. For example, when the length of the nozzle row is 1 inch, the intervals l₇ and l₉ can be set to be equal to or less than about 1 inch. In addition, the interval l₈ is shorter than the intervals l₇ and l₉.

In this configuration, since the intervals l₇ to l₉ of the first positioning hole 52 of the ink jet type recording head 1A can be made shorter to the length that is equal to or less than the nozzle row, even if the fixing member 60 is expanded or contracted due to temperature changes and humidity changes, when a relative position deviation of the nozzle rows of the head main bodies 10A occur, the amount of deviation can be reduced, and it is possible to suppress an occurrence of a stripe at the joint of the nozzle rows in the medium to be recorded.

In addition, in the embodiment, since the interval l₈ between the first positioning holes 52 adjacent to each other is very shorter than the intervals l₇ and l₉, it is possible to further reduce the amount of deviation of the first positioning holes 52 separated by the interval l₈ due to the temperature change and the humidity change.

Furthermore, in the embodiment, the head main bodies 10 of the same standard, in which the first positioning hole 52 and the second positioning hole 53 are provided at the same position, are used for the ink jet type recording head 1A. For this reason, compared to a case of using the plurality of head main bodies of different standards, the manufacturing cost can be reduced, the labor for managing the head main bodies for each standard can be excluded, and thus the cost can be reduced.

In addition, in the embodiment, since the second positioning holes 53 of the two head main bodies 102A and 103A provided in the center in the second direction Y approach each other, only in the two central head main bodies 102A and 103A, an amount of overlap can be reduced, and the deviation due to the influence of temperature changes and humidity changes does not nearly occur. Furthermore, if only two head main bodies 102A and 103B are provided in one ink jet type recording head 1A, the influence of the temperature change and the humidity change can be cancelled, and the deviation can be suppressed.

### Another Embodiment

Although the respective embodiments of the invention have been described above, the basic configuration of the invention is not limited to the above-mentioned configuration.

For example, in the ink jet type recording heads 1 and 1A of the above-mentioned respective embodiments, although the four head main bodies 10 and 10A are provided in one fixing member 60, a plurality of head main bodies 10 and 10A other than four may be provided in one fixing member 60, without being particularly limited thereto. Furthermore, in the embodiment, although the four head main bodies 10 and 10A forming the nozzle rows continued in the first direction X are provided in one fixing member 60, the rows of the head main bodies 10 and 10A constituting the nozzle rows continued in the first direction X may be arranged in one fixing member 60 in the plural lines, without being particularly limited thereto.

In addition, in the above-mentioned respective embodiments, although the two nozzle rows are provided in one head main bodies 10 and 10A, the nozzle row may be one row and may be three rows or more, without being particularly limited thereto.

In addition, in the above-mentioned respective embodiments, although the thin film type piezoelectric actuator 30 has been described as the pressure generation unit for causing the pressure change in the pressure generation chamber 22, for example, it is possible to use a thick film type piezoelectric actuator formed by a method of sticking a green sheet or the like, a longitudinal vibration type piezoelectric actuator configured to alternately superimpose the piezoelectric material and the electrode forming material and axially expand and contract the materials or the like, without being particularly limited thereto. Furthermore, as the pressure generation unit, it is possible to use a unit that places a heating element in the pressure generation chamber and discharges the liquid droplet from the nozzle openings by the bubble generated by the heat generation of the heating element, a so-called electrostatic type actuator that generates static electricity between a vibration plate and an electrode, modifies the vibration plate by electrostatic force, and discharges the liquid droplet from the nozzle openings or the like.

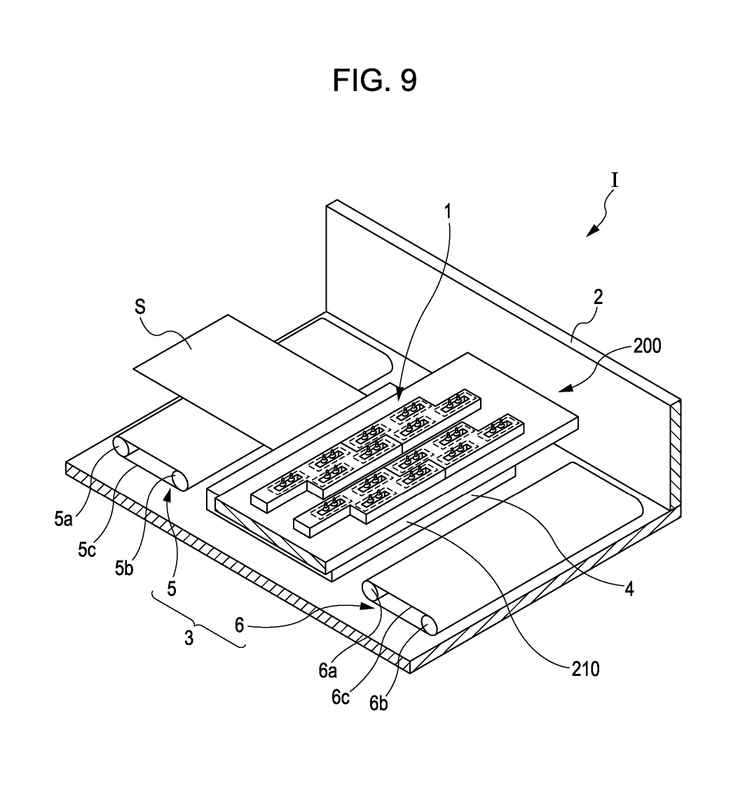

Furthermore, as shown in FIG. 9, the plurality (two in the embodiment) of ink jet type recording heads 1 and 1A of the above-mentioned respective embodiments is fixed to the holding member and constitutes an ink jet type recording head unit 200 that is an example of the liquid ejecting head unit. The ink jet type recording head unit 200 is mounted on the ink jet type recording apparatus that is an example of the liquid ejecting apparatus. Herein, the ink jet type recording apparatus of the embodiment will be described. In addition, FIG. 9 is a schematic perspective view that shows an ink jet type recording apparatus that is an example of the liquid ejecting apparatus related to Embodiment 1 of the invention.

As shown in FIG. 9, an ink jet type recording apparatus I of the embodiment is a so-called line type recording apparatus to which the ink jet type recording head unit 200 is fixed and performs printing by transporting a recording sheet S such as a paper as a medium to be ejected.

Specifically, the ink jet type recording apparatus I includes an apparatus main body 2, the ink jet type recording head unit 200 fixed to the apparatus main body 2, a transport unit 3 that transports the recording sheet S as the medium to be recorded, and a platen 4 that supports a back surface side opposite to the printing surfaces of the recording sheet S facing the ink jet type recording head unit 200.

The ink jet type recording head unit 200 includes two ink jet type recording heads 1, and a holding member 210 that holds the two ink jet type recording heads 1.

Furthermore, ink jet type recording head unit 200 is fixed to the apparatus main body 2 so that the first direction X as the arrangement direction of the nozzle opening 26 intersects with the transport direction of the recording sheet S.

The transport unit 3 includes a first transport unit 5 and a second transport unit 6 that are provided on both sides in the transport direction of the recording sheet S with respect to the ink jet type recording head unit 200.

The first transport unit 5 includes a driving roller 5a, a driven roller 5b, and a transport belt 5c wound around the driving roller 5a and the driven roller 5b. Furthermore, similarly to the first transport unit 5, the second transport unit 6 includes a driving roller 6a, a driven roller 6b and a transport belt 6c.

A driving unit such as a driving motor (not shown) is connected to the respective driving rollers 5a and 6a of the first transport unit 5 and the second transport unit 6, and transport belts 5c and 6c are rotated and driven by driving force of the driving unit, thereby to transport the recording sheet S on the upstream and downstream sides of the ink jet type recording head unit 200.

In addition, in the embodiment, although the first transport unit 5 and the second transport unit 6 constituted by the driving rollers 5a and 6a, the driven rollers 5b and 6b, and the transport belts 5c and 6c have been described, a holding unit configured to hold the recording sheet S on the transport belts 5c and 6c may be further provided. As the holding unit, for example, a charging unit configured to charge an outer peripheral surface of the recording sheet S may be provided, and the recording sheet S charged by the charging unit may be adsorbed on the transport belts 5c and 6c by the action of dielectric polarization. Furthermore, pressure rollers may be provided as the holding unit on the transport belts 5c and 6c, and the recording sheet S may be interposed between the pressure roller and the transport belts 5c and 6c.

The platen 4 is made of metal, resin or the like having a rectangular cross-section that is provided to face the ink jet type recording head unit 200 between the first transport unit 5 and the second transport unit 6. The platen 4 supports the recording sheet S transported by the first transport unit 5 and the second transport unit 6 in the ink jet type recording head unit 200 at the positions facing each other.

In addition, an adsorption unit configured to adsorb the transported recording sheet S on the platen 4 may be provided in the platen 4. For example, the adsorption unit includes a unit that sucks and adsorbs the recording sheet S by the adsorption, a unit that electrostatically adsorbs the recording sheet S by electrostatic force or the like.

Furthermore, although not shown, an ink storage unit such as an ink tank and an ink cartridge storing the ink is connected to the ink jet type recording head unit 200 so as to enable to supply the ink. For example, the ink storage unit may be held on the ink jet type recording head unit 200, may be held at a position in the apparatus main body 2 that is different from the ink jet type recording head unit 200, and may be connected to the ink supply needle 61 of each ink jet type recording head 1 via a tube or the like. In addition, external wiring (not shown) is connected to each ink jet type recording head 1 of the ink jet type recording head unit 200.

In the ink jet type recording apparatus I, the recording sheet S is transported by the transport unit 5, and the recording sheet S supported on the platen 4 is printed by the ink jet type recording head unit 200. The printed recording sheet S is transported by the transport unit 3.

In addition, in the example shown in FIG. 9, a so-called line type ink jet type recording apparatus I has been described in which the ink jet type recording head 1 (the ink jet type recording head unit 200) is fixed to the apparatus main body 2 and printing is performed only by transporting the recording sheet S. However, the invention can also be applied to a so-called serial type recording apparatus in which the ink jet type recording head 1 (the ink jet type recording head unit 200) is mounted on a carriage moved in a main scanning direction intersecting with the transport direction of the recording sheet S, and performs printing while moving the ink jet type recording head 1 (the ink jet type recording head unit 200) in the main scanning direction, without being particularly limited thereto.

In addition, in the above-mentioned embodiment, although the ink jet type recording head has been described as an example of the liquid ejecting head, the invention is widely related to the liquid ejecting head and, of course, can also be applied to a liquid ejecting head that ejects liquid other than the ink. Other liquid ejecting heads includes, for example, various recording heads used for an image recording apparatus such as a printer, a color material ejecting head used for manufacturing a color filter such as a liquid crystal display, an organic EL display, an electrode material ejecting head such as a FED (field emission display) used for forming the electrode, a living body organic matter ejecting head used for manufacturing a bio chip or the like.

The entire disclosure of Japanese Patent Application No. 2012-037117, filed Feb. 23, 2012 is incorporated by reference herein.

What is claimed is:

1. A liquid ejecting head comprising:
head main bodies having nozzle rows in which nozzle openings configured to eject liquid are arranged; and
a fixing member in which rows of the head main bodies arranged in a first direction as an arrangement direction of the nozzle openings are lined in a second direction perpendicular to the first direction, and the head main bodies are relatively positioned and fixed,
wherein the head main bodies are provided with first positioning holes and second positioning holes to which positioning pins are inserted,
the first positioning holes regulate the movement of the head main bodies with respect to the fixing member in the first direction as an arrangement direction of the nozzle openings and the second direction perpendicular to the first direction,
the second positioning holes regulate the movement of the head main bodies around the first positioning holes with respect to the fixing member in a rotary direction, and
intervals between the first positioning holes of each head main body are shorter than lengths of the nozzle rows of the head main bodies.

2. The liquid ejecting head according to claim 1,
wherein, in a plurality of the head main bodies, all positions of the first positioning holes and the second positioning holes with respect to the nozzle openings are provided at the same position.

3. The liquid ejecting head according to claim 2,
wherein all the intervals of the first positioning holes of the head main bodies adjacent to each other in the first direction are provided at uniform intervals.

4. The liquid ejecting head according to claim 2,
wherein, in the head main bodies that are arranged in the first direction to form a row, the first positioning holes and the second positioning holes are provided on the same side in the second direction, and
the rows of the head main bodies arranged in the second direction are the head main bodies provided at the opposite positions of the first positioning holes and the second positioning holes in the second direction.

5. The liquid ejecting head according to claim 1,
wherein the first positioning holes are provided on one end portion side of the head main bodies in the first direction, and the second positioning holes are provided on the other end portion side thereof, and
the two head main bodies adjacent to each other in the first direction are provided so that one end portion side provided with the first positioning holes of one head main body, and the one end portion side provided with the first positioning holes of the other head main body or the other end portion side provided with the second positioning holes are located at the same position in the first direction.

6. A liquid ejecting apparatus comprising the liquid ejecting head according to claim 1.

7. A liquid ejecting apparatus comprising the liquid ejecting head according to claim 2.

8. A liquid ejecting apparatus comprising the liquid ejecting head according to claim 3.

9. A liquid ejecting apparatus comprising the liquid ejecting head according to claim 4.

10. A liquid ejecting apparatus comprising the liquid ejecting head according to claim 5.
